(19) United States
(12) Patent Application Publication
(10) Pub. No.: US 2002/0065705 A1
(43) Pub. Date: May 30, 2002

(54) Method and system modifying questionnaire contents

(76) Inventors: Chih-Hua Wang, Taipei (TW); Hsing-Chun Hsieh, Taipei (TW)

Correspondence Address: BIRCH STEWART KOLASCH & BIRCH, PO BOX 747, FALLS CHURCH, VA, 22040-0747, US

(21) Appl. No.: 09/725,252

(22) Filed: Nov. 29, 2000

(51) Int. Cl. G06F 17/60

(52) U.S. Cl. 705/10

(57) ABSTRACT

The invention relates to a method for modifying questionnaire contents, comprising a recording procedure, an analysis procedure, and a modification procedure. The method is applied to a questionnaire with a plurality of questions, each of which having a plurality of options. The recording procedure stores in a questionnaire database the selection results of all questions obtained from the investigation using the questionnaire beforehand. The analysis procedure analyzes the selection ratios of all options according to the selection results. The modification procedure deletes a particular question from the questionnaire when the selection ratio of an option in the question is higher than a predetermined value. The specification also discloses a corresponding system of modifying questionnaire contents.

### BACKGROUND OF THE INVENTION

1. Field of Invention

The invention relates to a method and a system for modifying questionnaire contents and, in particular, to a method and a system of modifying questionnaire contents according to the investigation results of previous questionnaires.

2. Related Art

Using questionnaires for investigative purposes has become a very common method in personality studies or market investigations. By creating the questionnaires and analyzing the results, researchers or merchants that provide merchandise or services can learn the intentions of a questionee or such important information as how a questionee is satisfied with a particular product or service.

There are many factors that affect the accuracy of questionnaire investigations; one is the design of questionnaire contents, including the number, the content, and the order of the questions or even the relation of the questions to each other. If the questionnaire contents are ill designed (e.g., too many questions), they will not only have a negative effect on the investigation results but may also directly influence the willingness of the questionee to answer the questionnaire. For example, the questionee may refuse to answer the questionnaire because it is too long.

A new and growing trend in various activities and research is to use such features of the computer as fast speed, large memory capacity and high interactivity. Therefore, how to fully utilize the characteristics of the computer to provide a questionnaire with a well-designed content to increase the accuracy of the investigation results and the willingness of the questionee to answer questions has for some time been an important issue to be urgently solved.

### SUMMARY OF THE INVENTION

According to the above-mentioned problems, it is thus an objective of the invention to provide a method and a system of modifying questionnaire contents, which can improve the quality of a questionnaire by modifying the questionnaire contents according to the previous questionnaire investigation results.

It is another objective of the invention is to provide a method and a system of modifying questionnaire contents that can increase the willingness of the questionee to answer.

To achieve the above objective, the disclosed method of modifying questionnaire contents comprises a recording procedure, an analysis procedure and a modification procedure. The method is applied to a questionnaire with a plurality of questions, each of which having a plurality of options. The recording procedure stores in a questionnaire database the selection results of all questions obtained from the investigation using the questionnaire beforehand. The analysis procedure analyzes the selection ratios of all options according to the selection results. The modification procedure deletes a particular question from the questionnaire when the selection ratio of an option in the question is higher than a predetermined value.

The specification also discloses a corresponding system of modifying questionnaire contents comprising a storage device and a processing unit. The storage device stores a questionnaire database to record the selection results of all question options obtained from previous questionnaires. The processing unit executes an analysis procedure and a modification procedure, wherein the analysis procedure analyzes selection ratios of all options according to the selection results stored in the questionnaire database and the modification procedure deletes a particular question when the selection ratio of the option of the question is higher than a predetermined value.

### BRIEF DESCRIPTION OF THE DRAWINGS

The invention will become more fully understood from the detailed description given hereinbelow illustration only, and thus are not limitative of the invention, and wherein:

FIG. 1 is a flow chart showing the procedure of the method of modifying questionnaire contents according to a preferred embodiment of the invention;

FIG. 2(A) is a schematic view showing the data format stored in the questionnaire database according to a preferred embodiment method of modifying questionnaire contents;

FIG. 2(B) is a schematic view showing the selection ratio analysis results of all options according to a preferred embodiment method of modifying questionnaire contents;

FIG. 2(C) is a schematic view showing that the selection ratio analysis result in the analysis procedure 12 by simultaneously considering the basic data of the previous questionees according to a preferred embodiment method of modifying questionnaire contents; and

FIG. 3 is a schematic view showing a structure of a preferred embodiment system of modifying questionnaire contents.

### DETAILED DESCRIPTION OF THE INVENTION

The invention of a method and a system of modifying questionnaire contents will be apparent from the following detailed description, which proceeds with reference to the accompanying drawings, wherein the same references relate to the same elements.

Throughout the specification, a previous questionee refers to a questionee involved in a previous questionnaire investigation and a current questionee refers to a questionee involved in the current questionnaire investigation.

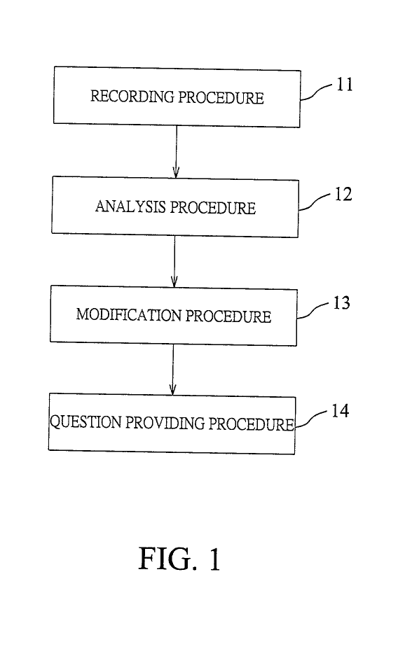

With reference to FIG. 1, the method of modifying questionnaire contents 1 in a preferred embodiment of the invention comprises a recording procedure 11, an analysis procedure 12, a modification procedure 13 and a question providing procedure 14. The recording procedure 11 records selection results of all question options in a previous questionnaire done by previous questionees. In addition, the questionnaire database can also store the basic data of previous questionees, such as age, gender or education.

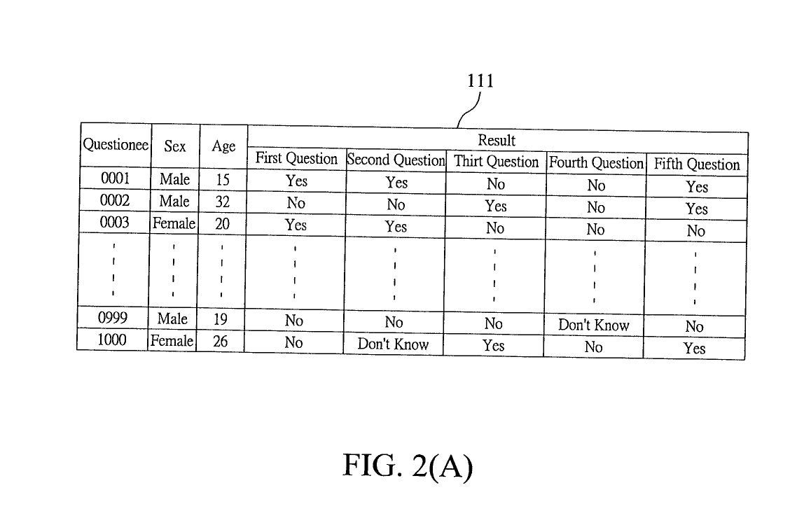

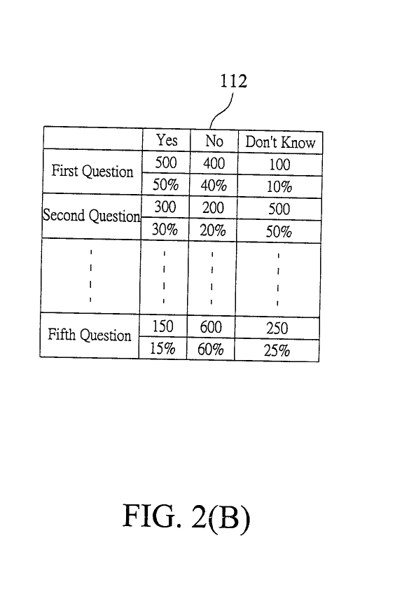

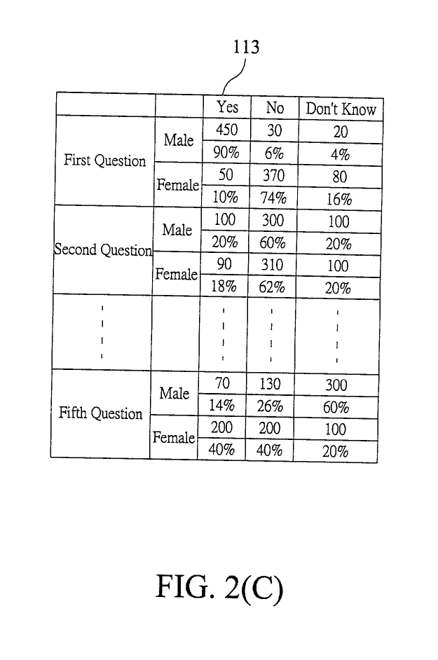

The data table 111 shown in FIG. 2(A) shows the data format stored in the questionnaire database. The data table 111 stores the record of 1000 persons who had completed the previous questionnaire, including their gender, age and question selections. In the questionnaire, each question has three options: YES, NO, and DON'T KNOW.

The analysis procedure 12 analyzes the selection ratios of all options according to the selection results in the data table 111. Referring to FIG. 2(B), if according to the data table 111 among those 1000 previous questionees, 500 persons answer YES, 400 persons answer NO, and 100 persons answer DON'T KNOW for the first question, then the selection ratios for the options YES, NO, and DON'T KNOW are 50%, 40% and 10%, respectively.

The analysis procedure 12 can also consider the basic data of the previous questionees before analyzing the selection ratios of all options. With reference to FIG. 2(C), the analysis table 122 shows the analysis results obtained after first considering the gender of the questionee. According to the data table 111, there are 500 males and 500 females among the 1000 previous questionees. The number of males selecting YES, NO and DON'T KNOW are 450, 30 and 20, respectively. The number of females selecting YES, NO and DON'T KNOW are 50, 370 and 80, respectively. As shown in the analysis table 122, the selection ratios for the three options are 90%, 6% and 4%, respectively, for the previous male questionees and 10%, 74% and 16%, respectively, for the previous female questionees.

Afterwards, the modification procedure 13 performs modifications to the questionnaire contents. When the selection ratio of a particular option in a particular question is higher than a predetermined value, the modification procedure 13 deletes the particular question from the questionnaire. The predetermined value can be set by design, e.g., 95% or 90%. The reason for the deletion is when the selection ratio of a particular option is higher than a predetermined value, the option can be regarded as a “definite option” . When a question contains a “definite option”, the question becomes redundant and should therefore be deleted in order to minimize the number of questions in the questionnaire and to increase the current questionee's will to answer the questionnaire.

If in the previous analysis procedure 12 the basic data of the previous questionees are considered at the same time, the basic data of the current questionees can be taken into account too to generate different questionnaire content when performing the modification procedure 13. For example, according to the results shown in FIG. 2(C), since the selection ratio of YES in the first question done by the previous male questionees is 90%, the first question is viewed as a question with a “definite option” and should be deleted from the questionnaire for the current male questionees. However, there is no “definite option” in the first question for the previous female questionees, this question should be kept in the current questionnaire for the current female questionees.

The question providing procedure 14 provides questions in the questionnaire to a current questionee. In the current embodiment, the question providing procedure 14 sends through the Internet each question in the questionnaire to the computer of the current questionee to be shown on the monitor thereof. The current questionee can directly answer the questionnaire using a keyboard or a mouse and send back the answers to a questionnaire server through the Internet. It should be noted, however, that the question providing procedure 14 can also provide the questions through phone voice mail or by fax, but is not limited by the above-mentioned Internet transmission.

In the question providing procedure 14, in addition to simultaneously providing all questions in the questionnaire to the current questionee, it can utilize the feature of high computer interactivity to provide one question at a time to the current questionee so that the current questionee cannot see subsequent questions when answering a particular question. This method can avoid the situation in which the selection may be affected by being able to see subsequent questions. The current questionee can answer the current question independently of subsequent questions.

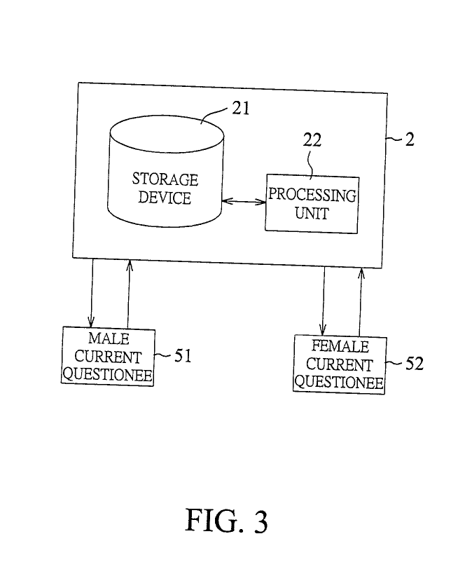

The method of modifying questionnaire contents in a preferred embodiment of the invention can be implemented on a network server so as to perform questionnaire investigations to a questionee through the Internet. Referring to FIG. 3, the system of modifying questionnaire contents 2 according to a preferred embodiment of the invention is a network server comprising a storage device 21 and a processing unit 22. The storage device 21 stores a questionnaire database that records selection results of all question options in the questionnaire collected in the previous questionnaire investigation. The processing unit 22 executes the recording procedure 11, an analysis procedure 12, a modification procedure and a question providing procedure 14 to modify the questionnaire contents and to provide them to the current questionee.

In FIG. 3, the system of modifying questionnaire contents 2 simultaneously connect to two current questionees through the Internet, namely, a male current questionee 51 and a female current questionee 52. As described above, the analysis procedure 12 and the modification procedure 13 executed by the system of modifying questionnaire contents 2 can change the questionnaire contents according to the basic data of the current questionee. Therefore, the questionnaires received by the male current questionee 51 and the female current questionee 52 will have different contents. In other words, the system of modifying questionnaire contents 2 will first analyze the results given by the previous questionees and then provide the most suitable questionnaire contents to the current questionee so as to improve the questionnaire quality and to increase the questionee's will to answer the questionnaire.

In conclusion, the method and system of modifying questionnaire contents according to the invention can delete unnecessary questions contained therein through the analysis of the previous questionnaire results. Therefore, the invention can effectively improve the quality of the questionnaire to increase the current questionee's will to answer.

The method and system of modifying questionnaire contents of the invention can provide different current questionees different questionnaire contents according to their basic data and can therefore increase the current willingness of the questionee to answer.

The method and system of modifying questionnaire contents of the invention can obtain more accurate and valid questionnaire results through computer technology.

Certain variations would be apparent to those skilled in the art, which variations are considered within the spirit and scope of the claimed invention.

What is claimed is:

1. A method of modifying questionnaire contents of a questionnaire with a plurality of questions, each of which having a plurality of options, the method comprising:
a recording procedure, which records in a questionnaire database selection results of the options of the questions obtained in the previous questionnaire;
an analysis procedure, which analyzes selection ratios of the options according to the selection results; and
a modification procedure, which deletes a particular problem from the questionnaire when the selection ratio of a particular option is higher than a predetermined value.

2. The method of claim 1, wherein:
the recording procedure further stores in the questionnaire database basic data of previous questionees involved in the previous questionnaire; and
the analysis procedure further considers the basic data of the previous questionees when analyzing the selection ratios of the options.

3. The method of claim 1 further comprising a question providing procedure, which provides the questions in the questionnaire to a current questionee.

4. The method of claim 3, wherein the modification procedure further takes into account the basic data of the current questionee in order to help in deleting the particular question from the questionnaire in the modification procedure.

5. The method of claim 3, wherein the question providing procedure simultaneously provides all of the questions to the current questionee.

6. The method of claim 3, wherein the question providing procedure provides one of the questions to the current questionee at a time.

7. A system of modifying questionnaire contents of a questionnaire with a plurality of questions, each of which having a plurality of options, the system comprising:
a storage device, which stores a questionnaire database that records the selection results of the options in the questions obtained in the previous questionnaire;
a processing unit, which executes an analysis procedure and a modification procedure, wherein the analysis procedure analyzes the selection ratios of the options according to the selection results stored in the questionnaire database, and the modification procedure deletes a particular problem from the questionnaire when the selection ratio of a particular option is higher than a predetermined value.

8. The system of claim 7, wherein
the questionnaire database further stores the basic data of previous questionees involved in the previous questionnaire; and
the processing unit further considers the basic data of the previous questionees when analyzing the selection ratios of the options in the analysis procedure.

9. The system of claim 7, wherein the processing unit further executes a question providing procedure to provide the questions in the questionnaire to a current questionee.

10. The system of claim 9, wherein the processing unit further takes into account the basic data of the current questionee in order to help in deleting the particular question from the questionnaire in the modification procedure.

11. The system of claim 9, wherein processing unit simultaneously provides all of the questions to the current questionee in the question providing procedure.

12. The system of claim 9, wherein the processing unit provides one of the questions to the current questionee at a time in the question providing procedure.
